(19) United States
(12) Patent Application Publication
(10) Pub. No.: US 2011/0011706 A1
(43) Pub. Date: Jan. 20, 2011

(54) DEVICE FOR TESTING SUBSTRATES

(76) Inventor: Gerhard Meyer, Neusaess (GE)

Correspondence Address: EDWIN D. SCHINDLER, 4 HIGH OAKS COURT, P.O. BOX 4259, HUNTINGTON, NY, 11743-0777, US

(21) Appl. No.: 12/833,538

(22) Filed: Jul. 9, 2010

(30) Foreign Application Priority Data
Jul. 14, 2009 (DE) 10 2009 032 928.5

(51) Int. Cl. B65G 23/19

(52) U.S. Cl. 198/811

(57) ABSTRACT

A device for testing substrates includes magnetic elements, preferably printed products printed with magnetic printing ink. The device has a powered suction belt travelling around it, which transports the substrates under a measuring device and is assigned to the top of at least one extractable air space. At least one suction fan is assigned to the suction belt and is connected to the air space. At least the suction belt is made of a non-ferromagnetic material. Each suction fan assigned to the suction belt takes the form of a motorless fan, which is connected to a remote power source by way of a transmission.

### FIELD OF THE INVENTION

This invention relates to a device for testing substrates which feature magnetic elements, in particular for testing printed products printed with magnetic printing ink.

### BACKGROUND OF THE INVENTION

Magnetic printing ink is often used for the production of security-relevant products such as share certificates, identification documents, etc. The use of different printing inks allows a unique magnetic profile to be created. However, the magnetic field strength of items printed with such ink is extremely low which means that highly sensitive sensors are required to identify the magnetic profile. This means that there is a risk that even minor external influences will lead to the falsification of the measurement results. The same applies, of course, to fluctuations relating to the distance between the substrates and the measuring device and their relative velocity to the measuring device.

On this basis, therefore, the aim of this invention is to create a device of the type outlined above which ensures high measuring accuracy and therefore high testing quality.

### SUMMARY OF THE INVENTION

This aim is achieved by the following proposal.

A device with a powered suction belt travelling around it, which transports the substrates under a measuring device which is assigned to the top of at least one extractable air space, to which in turn at least one suction fan assigned to the suction belt is connected wherein at least the suction belt is made of non-ferromagnetic material and each suction fan assigned to the suction belt takes the form of a motorless fan which is connected to a remote power source by means of a transmission.

These measures solve the problem described above in an extremely simple, cost-effective way. The substrates on the suction belt are held precisely on the surface of the suction belt by the suction draught generated by the suction fan or suction fans so that the substrates are transported by the belt without slipping. The distance of the substrates from the measuring device and their relative velocity compared to the measuring device can be kept almost constant as a result of this, which precludes the possibility of sources of error originating from these factors. The generation of magnetic interference fields which could affect the measurement is effectively prevented since the suction belt is made of non-ferromagnetic material and each fan assigned to it takes the form of a motorless fan. This means that overall it is possible to expect precise measurement results.

Advantageous forms and expedient developments of the main measures are described in the sub-claims.

For example, the suction belt may expediently take the form of a spiral belt screen made of fibrous plastic material. This measure enables the belt to be manufactured with great precision and without any notable thickness tolerances which could change the distance between the substrate and the measuring device. In addition, a spiral belt screen ensures good air permeability which in turn ensures the high effectiveness of the suction draught on the surface of the suction belt created by the suction fan(s).

Another helpful measure may be that the suction belt has a substructure which is permeable to air and is made of a non-ferromagnetic material, preferably in the form of a perforated panel. This allows the vibrations of the suction belt to be reliably prevented which has a beneficial effect on maintaining a precise distance between the substrates being transported on the suction belt and the measuring device.

The extractable air space may helpfully be divided into several compartments partitioned by walls made of non-ferromagnetic material each of which has at least one suction fan assigned to it. This allows the suction draught to be homogenised over a comparatively long transport distance.

In a further development of the main measures the extractable air space may take the form of an insert in a frame wherein the power source for the suction fans takes the form of a motor located beneath the insert which is expediently in the corner of the frame which is furthest away from the measuring device. This reliably counteracts any influence the motor may have on the measurement results.

Another beneficial measure may be that the transmission takes the form of a belt transmission with elements made of a non-ferromagnetic material. Belt drives helpfully produce comparatively quiet and smooth operation. In addition this ensures that the belts can easily be turned around rollers and twisted into themselves which simplifies the design of the transmission.

The extractable air space may helpfully have several suction fans positioned one after the other in the longitudinal direction wherein neighbouring suction fans are connected to each other by belts. At the same time each compartment may also have fans positioned next to each other at a right-angle to the direction in which the suction belt travels wherein a roller powered by the power source may be installed over the full width of the frame or insert with which several belts assigned to fans positioned next to each other interact and through which the roller crosses at an angle of 90°. The fans may helpfully be fitted with drive wheels on an axis perpendicular to the suction belt which will make for a space-saving design.

Ideally all the components which partition the extractable air space and/or components mounted in it or on it may be made of non-ferromagnetic material which will have a positive effect on the measurement accuracy.

Other beneficial designs and expedient developments of the main measures are described in the other sub-claims and are also shown in the specimen description provided below based on the drawing.

### BRIEF DESCRIPTION OF THE DRAWING FIGURES

The drawing described below shows the following:

FIG. 1 A perspective view of a device proposed by the invention with an open side panel.

FIG. 2 A longitudinal section through the device shown in FIG. 1.

FIG. 3 A plan view of the device proposed by the invention from below.

### DETAILED DESCRIPTION OF THE DRAWING FIGURES AND PREFERRED EMBODIMENTS

The main application of the invention is for testing security-relevant products printed with magnetic ink, in particular share documents.

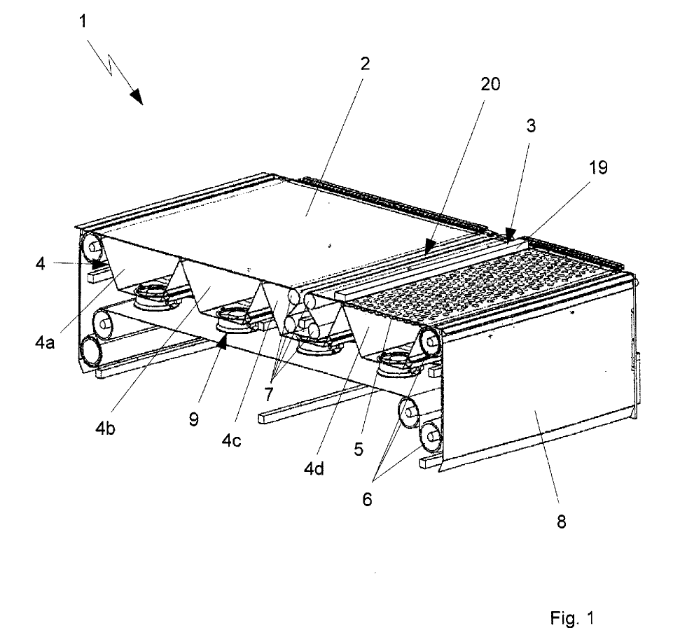

FIG. 1 shows a suction table 1 with a powered suction belt 2 travelling around it on which the substrates for testing (not shown) are transported under a measuring device 3 to undergo a magnetic testing process. The measuring device 3 in this case has a transmitted light testing device 20 downstream of it which will be described briefly later. The transmitted light testing device 20 may, however, also be located upstream of the measuring device 3. The suction belt 2 is assigned to the top of an extractable air space 4 wherein this covers the top of the air space 4 which may at least in part be open. The suction belt 2 is made of non-ferromagnetic material and preferably consists of a spiral belt screen made of fibrous plastic material. This can be manufactured with very low tolerances and is ideally up to approx. 50% permeable to air. The suction belt 2 will helpfully also have an air-permeable substructure made of non-ferromagnetic material which takes the form of a perforated panel 5. This panel 5 may be made of wood and/or plastic and is designed to prevent vibration of the suction belt 2 so as to maintain the required distance between the substrates being transported on it and the measuring device 3. As FIG. 1 shows, the panel 5 extends in the direction of travel of the suction belt 2 from the infeed point to shortly before the transmitted light testing device 20, in other words it does not cover the full top side of the extractable air space 4. It would also be conceivable that the panel 5 extends over the full surface of the suction table 1 wherein a gap should be left near the transmitted light testing device 20 for the light to pass through.

Deflecting rollers 6 are fitted near the top and bottom ends of the air space 4 to guide the suction belt 2, as shown in FIG. 1. At least one of these deflecting rollers 6 can be powered to move the suction belt 2 and therefore transport the substrates positioned on the suction belt 2. Furthermore there are other deflecting rollers 7, four in number, located in the air space 4 and assigned to the transmitted light testing device 20 which deflect the suction belt 2 in the form of a loop. The deflecting rollers 7 are arranged in the form of a trapezoid wherein the deflecting rollers 7 which deflect the suction belt 2 first and last (upper deflecting rollers) are closer together in the horizontal direction than the other two deflecting rollers 7 located below them. The gap between the two upper deflecting rollers 7 allows the light required for the transmitted light test on the substrate carried out using the transmitted light testing device 20 to pass through. The substrates transported through the transmitted light testing device 20 can thus be transilluminated.

However, the arrangement of the deflecting rollers 7 also helps to further tension the suction belt 2 around the measuring device 3, so that in addition to the panel 5, this measure also ensures that the distance between the substrates being transported on the suction belt 2 and the measuring device 3 can continue to be maintained precisely. The air space 4 which is enclosed at the top by the suction belt 2 may helpfully take the form of an insert which, like the deflecting rollers 6, is mounted on a frame 8.

The air space 4 is divided into several compartments 4a, 4b, 4c and 4d partitioned by walls made of non-ferromagnetic material. The number of compartments depends on the length of the suction table 1. The transmitted light testing device 20 is located in compartment 4c which is downstream of the measuring device 3. All these compartments 4a, 4b, 4c and 4d have at least one suction fan 9 which extracts the air from the compartment 4a, 4b, 4c or 4d to which it is assigned. The suction this generates sucks the substrates through the panel 5 and the suction belt 2 on to the belt enabling them to be transported without any slipping. It is particularly expedient if the compartments 4a, 4b, 4c and 4d each have more than one suction fan 9 as shown in FIG. 3.

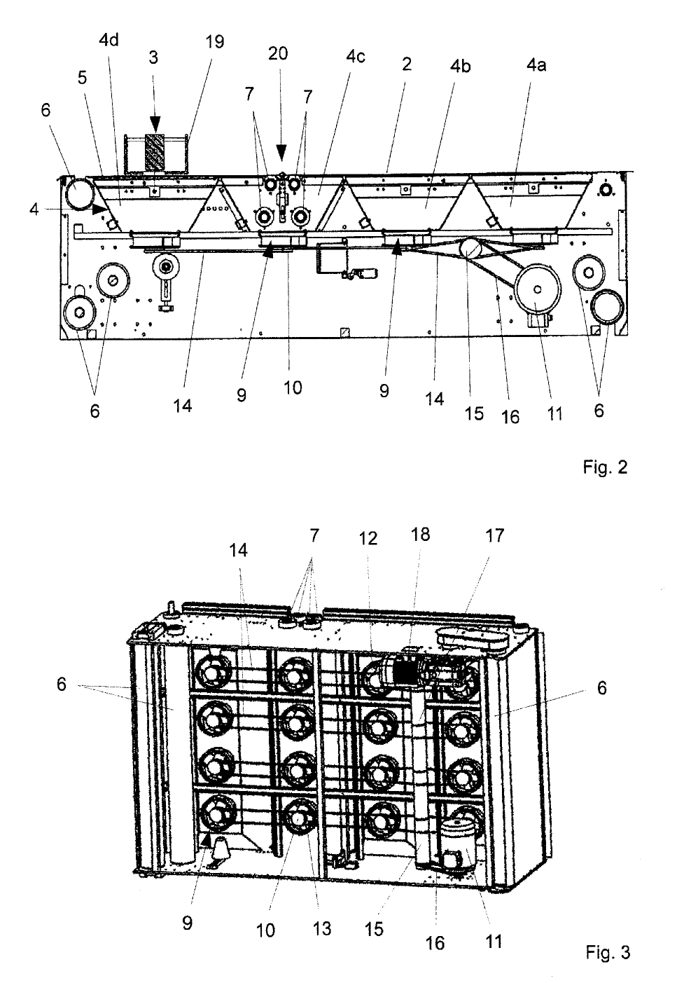

Each suction fan 9 has a drive wheel 10 located on an axis perpendicular to the suction belt 2 which is connected to a remote power source 11 by means of a belt transmission, as can be seen particularly clearly in FIGS. 2 and 3. The power source 11 takes the form of a motor positioned below the air space 4 in the area of the bottom corner of the frame 8 furthest away from the measuring device 3. That means that the power source 11 is located at the diametrically opposite side to the measuring device 3 and outside the extractable air space 4 so that it cannot have any influence on the measurement so that precise measurement results can be achieved.

As shown in FIG. 3 in the plan view from below the suction table 1, there are several suction fans 9 assigned to the extractable air space 4. There are also several suction fans 9 located side by side at a right-angle to the direction of travel of the suction belt 2 and assigned to each compartment 4a, 4b, 4c and 4d so as to create rows of suction fans running in the direction of travel of the suction belt 2 and at a right-angle to it. The suction fans 9 are fitted with suction nozzles in the floor area of the various compartments 4a, 4b, 4c and 4d so that the main part of the suction fan 9 is outside the air space 4. Each individual suction fan 9 has fan blades which partition the air space 4 and which are fitted on a shaft and combine to form the fan wheels 12. The drive wheels 10 take the form of round belt pulleys 13. The drive belts 14 to drive the various suction fans 9 take the form of round belts. The suction fans 9 in compartments 4a and 4d have single round belt pulleys 13. The suction fans 9 in compartments 4b and 4c, on the other hand, have double round belt pulleys 13 so that these pulleys can each hold two drive belts 14 wherein the two drive belts 14 fitted on a double round belt pulley 13 are connected to the neighbouring suction fans 9 to the right and left of them. This allows the suction fans 9 located along the direction of travel of the suction belt 2 to be interconnected and interact with each other.

To ensure that the various suction fans 9 in compartments 4a, 4b, 4c and 4d can also be driven by the power source 11, there is a roller 15 which extends over the full width of the suction belt 2 below the air space 4 and inside the frame 8 which can be powered by the power source 11 using a primary drive belt 16 which connects the two elements. The roller 15 is positioned between compartments 4a and 4b as shown in FIG. 3 so that the roller 15 is fitted between two lateral rows of suction fans 9. Naturally it is also possible to have a different arrangement of the roller 15. To power the suction fans 9 by the roller 15 using the drive belts 14 it is necessary for the drive belts 14 to interact with the roller 15.

The drive belts 14 crossed by the roller 15 are driven by the roller 15. For this purpose the drive belts 14 are crossed in such a way that their forwards and backwards sections are in contact with the roller 15. The roller 15 features grooves 17 to form tracks for the drive belts 14. The various suction fans 9 are therefore driven by the power source 11 using the primary drive belt 16 on the roller 15 and also by the drive belts 14 on the drive wheels 10 of the suction fans 9 making the fan wheels 12 rotate. By these means the air in the various compartments 4a, 4b, 4c and 4d can be extracted to generate the suction required to fasten and hold the substrates on the suction belt 2. The various suction fans 9 therefore do not require a power source 11 of their own. The belt transmission is also made of non-ferromagnetic elements so that this, too, does not cause any negative effects on the measurement result.

FIG. 3 also shows a main power source 18 for the suction belt 2. This main power source 18 is also located in a position in the frame 8 which is furthest away from the measuring device 3. As FIG. 3 shows, the main power source 18 is positioned in a corner of the frame 8 which is opposite the power source 11. Therefore the main power source 18 will also not negatively affect the measurement result.

As shown in particular in FIGS. 1 and 2, the measuring device 3 runs at a right-angle to the direction of travel over the entire width of the suction belt 2. The measuring device 3 is assigned to a tie bar 19 which extends over the extractable air space 4 wherein it may be positioned in the direction of travel of the suction belt 2 at the end of the perforated panel 5 as shown in FIGS. 1 and 2. However, it may also be located in another position on the perforated panel 5. The sensors which form the measuring device 3, for example Hall sensors which measure the magnetic field generated by the substrate being tested, are mounted on the tie bar 19. Since this is very low, however, the sensors must be highly sensitive. Therefore there must be not even very small magnetic interference fields emanating from ferromagnetic materials near the measuring device 3.

To take account of this the tie bar 19, like all the elements which partition the extractable air space 4 and/or are positioned inside it or on it, must be made of a non-ferromagnetic material, for example plastic.

To carry out the test the substrate held on the suction belt 2 by the suction draught in the front area of the perforated panel 5 is transported along the perforated panel 5 up to the measuring device 3 as shown in FIG. 1. The substrate is also transported under the measuring device 3 which measures the magnetic field strength or the magnetic profile using the sensors to allow conclusions to be drawn as to the authenticity of the substrate. The data recorded by the sensors are supplied to a data device which is not shown, which evaluates the recorded measurement results.

After this measurement the substrate is transported further to a transmitted light testing device 20 where the other security-relevant aspects of the substrate are tested. The transmitted light testing device 20 has a lighting device below the suction belt level which is not shown and a camera unit located above the level of the suction belt (which is also not shown). The reverse arrangement with the camera unit underneath and the lighting device above would also be conceivable. The lighting device contains at least one light source, for example a light-emitting diode. The camera unit ideally takes the form of a line camera which records a line-type section over the entire width of the substrate in a certain screen which is adjusted to suit the required image resolution. The data which correspond to these images are sent by the camera to an electronic evaluation unit which is not shown which composes a complete image from these data and draws the required conclusions about the substrate from this image.

1-15. (canceled)

16. An apparatus for testing substrates, comprising magnetic elements having a suction belt for transporting the substrates under a measuring device assigned to the top of at least one extractable air space to which at least one suction fan assigned to the suction belt is connected, wherein at least the suction belt is made of a non-ferromagnetic material and each suction fan assigned to the suction belt is a motorless fan and is connected to a remote power source via a transmission.

17. The apparatus for testing substrates according to claim 16, wherein said suction belt is a spiral belt screen made of fibrous plastic material.

18. The apparatus for testing substrates according to claim 16, wherein said suction belt includes an air-permeable substructure made of non-ferromagnetic material.

19. The apparatus for testing substrates according to claim 18, wherein said substructure is a perforated panel is made of at least one of wood and plastic.

20. The apparatus for testing substrates according to claim 16, wherein said suction belt is guided around deflecting rollers made of a non-ferromagnetic material.

21. The apparatus for testing substrates according to claim 20, wherein at least one of said deflecting rollers is powered.

22. The apparatus for testing substrates according to claim 16, wherein the extractable air space is divided into a plurality of compartments partitioned by walls made of a non-ferromagnetic material, each compartment of said plurality of compartments having at least one suction fan.

23. The apparatus for testing substrates according to claim 16, wherein extractable air space takes the form of an insert of a frame having a power source included as a motor located under the insert.

24. The apparatus for testing substrates according to claim 23, wherein said motor is positioned in an area of a bottom corner of the frame furthest away from the measuring device.

25. The apparatus for testing substrates according to claim 16, wherein said transmission is a belt transmission having elements made of a non-ferromagnetic material.

26. The apparatus for testing substrates according to claim 16, wherein a plurality of said suction fans positioned one after the other in a longitudinal direction of said suction belt are assigned to the extractable air space, wherein adjacent fans are inter-connected by belts with at least one being drivable via the power source.

27. The apparatus for testing substrates according to claim 26, wherein each compartment of a plurality of compartments includes several suction fans arranged side-by-side and at a right-angle to the direction of travel of the suction belt, wherein a roller is fitted running the full width of the suction belt and drivable by the power source with which belts assigned to said several suction fans arranged side-by-side interact.

28. The apparatus for testing substrates according to claim 27, wherein each said suction fan has a drive wheel located on an axis perpendicular to the suction belt and that the belts which interact with the roller are crossed by the roller (15) at an angle of 90°.

29. The apparatus for testing substrates according to claim 16, wherein all said magnetic elements partitioning said extractable air space or mounted in or thereon are made of a non-ferromagnetic material.

30. The apparatus for testing substrates according to claim 16, wherein said measuring device has a tie bar covering the extractable air space.
